(19) United States
(12) Patent Application Publication
(10) Pub. No.: US 2024/0289674 A1
(43) Pub. Date: Aug. 29, 2024

(54) QUANTUM CIRCUIT CUTTING VS SIMULATION: AN ORCHESTRATION DECISION

(71) Applicant: Dell Products L.P., Round Rock, TX (US)

(72) Inventors: Rômulo Teixeira de Abreu Pinho, Niterói (BR); Miguel Paredes Quiñones, Campinas (BR); Micael Veríssimo de Araújo, Rio de Janeiro (BR); João Victor Pinto, Rio de Janeiro (BR); Alexander Eulalio Robles Robles, Valinhos (BR)

(21) Appl. No.: 18/174,328

(22) Filed: Feb. 24, 2023

(51) Int. Cl. G06N 10/60; G06N 10/80

(52) U.S. Cl. CPC G06N 10/60; G06N 10/80

(57) ABSTRACT

One example method includes providing quantum circuit information, concerning a quantum circuit, to a first machine learning model that has been trained with first training data generated as a result of execution of a group of quantum circuits on a simulation engine, providing the quantum circuit information to a second machine learning model that has been trained with second training data generated as a result of execution of the group of quantum circuits on quantum hardware, estimating, by the first machine learning model and the second machine learning model, respective values of a quantum circuit execution parameter of the quantum circuit, comparing the estimates of the quantum circuit execution parameter, and based on the comparing, orchestrating the quantum circuit to either the simulation engine, or the quantum hardware, for execution.

### FIELD OF THE INVENTION

Embodiments of the present invention generally relate to the interplay between quantum computing and classical computing. More particularly, at least some embodiments of the invention relate to systems, hardware, software, computer-readable media, and methods, for determining whether, and under what conditions, a quantum circuit will be executed on quantum hardware or classical computing hardware.

### BACKGROUND

Quantum circuit cutting is a strategy that can be used to divide a large quantum circuit into small subcircuits which can be executed individually. This approach may be needed in some circumstances because quantum computers have limitations on the depth and number of qubits. Once executed on the quantum subcircuits, the results must then be merged together by a classical postprocessing operation, sometimes referred to as ‘knitting,’ from which emerges a computationally costly combinatorial problem. Since obtaining and running these subcircuits may be considered a workload in a hybrid, that is, classical/quantum, computational infrastructure, the execution of the subcircuits may be considered as part of a workload orchestration solution. For example, the cutting may enable the execution of large quantum circuits across different quantum architectures, or even allow the combination of quantum hardware and simulation engines.

Considering the typically large sizes of classical high-performance computing (HPC) infrastructures, and the still very limited availability of large quantum computers, a question that arises is whether running a circuit via simulations on classical infrastructures is more efficient than doing the expensive cutting and knitting processes on quantum hardware infrastructure. This question is relevant in the hybrid quantum-classic orchestration space, where there may be a need to provide classical infrastructure that seamlessly integrates with quantum infrastructure.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture, including an orchestrator, quantum hardware, and a simulation engine comprising classical computing hardware, according to an embodiment.

FIG. 2 discloses an example adjacency matrix, according to an embodiment.

FIG. 3 discloses aspects of a quantum circuit transformation process, according to an embodiment.

FIG. 4 discloses an example orchestration algorithm, according to an embodiment.

FIG. 5 discloses an example method, according to an embodiment.

FIG. 6 discloses an example computing entity, which may comprise quantum hardware and/or classical computing hardware, including a simulation engine, and which is configured and operable to perform any of the disclosed methods, processes, and operations.

### DETAILED DESCRIPTION OF SOME EXAMPLE EMBODIMENTS

Embodiments of the present invention generally relate to the interplay between quantum computing and classical computing. More particularly, at least some embodiments of the invention relate to systems, hardware, software, computer-readable media, and methods, for determining whether, and under what conditions, a quantum circuit will be executed on quantum hardware or classical computing hardware.

In general, an embodiment of the invention comprises a mechanism by way of which a choice between quantum simulation and quantum hardware can be made based on Service Level Agreement (SLA) constraints. Such a mechanism may be based on prediction engines, which may comprise machine learning (ML) models, that estimate Quality of Service (QOS) metrics, such as execution time for example, associated with running a quantum circuit on a simulation engine, and on quantum hardware that requires cutting and knitting operations to be performed. Note that as used herein, a ‘simulation engine’ embraces, but is not limited to, a classical hardware implemented simulation of one or more quantum circuits.

In one particular embodiment, a training data set is generated that includes various attributes collected during the execution of one or more quantum circuits on both classical computing infrastructure, that is, a simulation engine, and quantum hardware. In an embodiment, the attributes are invariant with respect to quantum circuit size, and a graph of the circuit may be converted to a uniform vectorial representation that may be an input to an ML model. The execution of the quantum circuits may also provide ground truth metrics, such as execution time and memory/CPU usage for example. The training data set may then be used to train two different ML models, one for the simulation engine and one for the quantum hardware, to learn the relationships between the input, that is, circuit features, and the ground truth metrics. In an online stage, when executing a new circuit, the trained models may each estimate respective QoS metrics of simulating the new circuit on classical infrastructure, and executing the new circuit on quantum hardware. Based on SLA requirements, as reflected in the QoS metrics, a decision may then be made as to whether the new circuit should be executed on the quantum hardware, or on a simulation engine of a classical computing infrastructure.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that SLA requirements may be used as a basis to determine whether a quantum circuit should be executed on classical infrastructure, or on quantum hardware. An embodiment may identify and implement a computing infrastructure best suited, as among available alternatives, to meet customer SLA requirements. Various other advantages of one or more embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

An example embodiment of the invention, in contrast with conventional approaches, is directed to SLA-oriented choices between quantum simulation, and execution of circuits on real quantum hardware. More specifically, an embodiment may operate to choose between the execution of a quantum circuit on a simulation engine, or execution of the quantum circuit on real quantum hardware after performing a cutting operation. Thus, an embodiment may predict the respective QoS metrics of the two different quantum circuit execution approaches, and may do so without actually executing any quantum operations. In particular, a method according to one embodiment comprises a machine learning technique that learns associations between circuit patterns and the referred QoS metrics. Aspects of one embodiment of the invention are set forth hereafter.
1. Initially, a training data set may be built that contains the following attributes collected from several executions of quantum circuits both on classical computing infrastructure, and on quantum hardware:
a. features of the quantum circuit that capture the size, depth, and level of entanglement of the qubits on the circuit—such features, which may be invariant to the circuit size, may be directly related to the complexity of the simulation and the cutting operation—because such features are invariant in this way, an embodiment may comprise a mechanism that transforms a quantum circuit graph into a uniform vectorial representation, that is, an embedding, that may be used as input of a machine learning model (“In quantum computing, a graph state is a special type of multi-qubit state that can be represented by a graph. Each qubit is represented by a vertex of the graph, and there is an edge between every interacting pair of qubits. In particular, they are a convenient way of representing certain types of entangled states.”—see, e.g., https://en.wikipedia.org/wiki/Graph_state); and
b. ground-truth metrics, such as execution times or memory/CPU consumption for example, collected from the execution of several circuits on both the simulation engine and the available quantum hardware, including the execution of any cutting and knitting operation(s).
2. Train two different machine learning models to learn the relationship between the input features and the ground-truth metrics, that is, one ML model for the simulation engine, and one ML model for both the quantum hardware and cutting-knitting operation(s).
3. When executing a new circuit, it is then possible to use the trained ML models to estimate the respective QoS metrics of (a) simulating the circuit on classical computing infrastructure, and of (b) running the circuit cutting algorithm, plus executing the subcircuits on the quantum hardware.
4. Choose where to run the circuit, based on the SLA constraints given by the user, such as maximum execution time or budget for example, that is, on a simulation engine, or on quantum hardware, which may also include the execution of any cutting and knitting operations.

Thus, as the foregoing indicates, an embodiment of the invention may possess various useful aspects and features. For example, an embodiment may comprise an orchestration mechanism that enables the execution of an arbitrarily sized quantum circuit on either a simulation engine running on classical HPC infrastructure, or on quantum hardware after performing a circuit cutting operation. As another example, an embodiment may comprise a machine learning (ML) approach that learns the relationship between input features related to the quantum circuit, and the QoS metrics of running a such circuit on either a simulation engine or some quantum hardware. Further, an embodiment may comprise an embedding mechanism that transforms a quantum circuit, of arbitrary size and configuration, into a vectorial representation that may be used in the training of machine learning models.

### B. Detailed Description

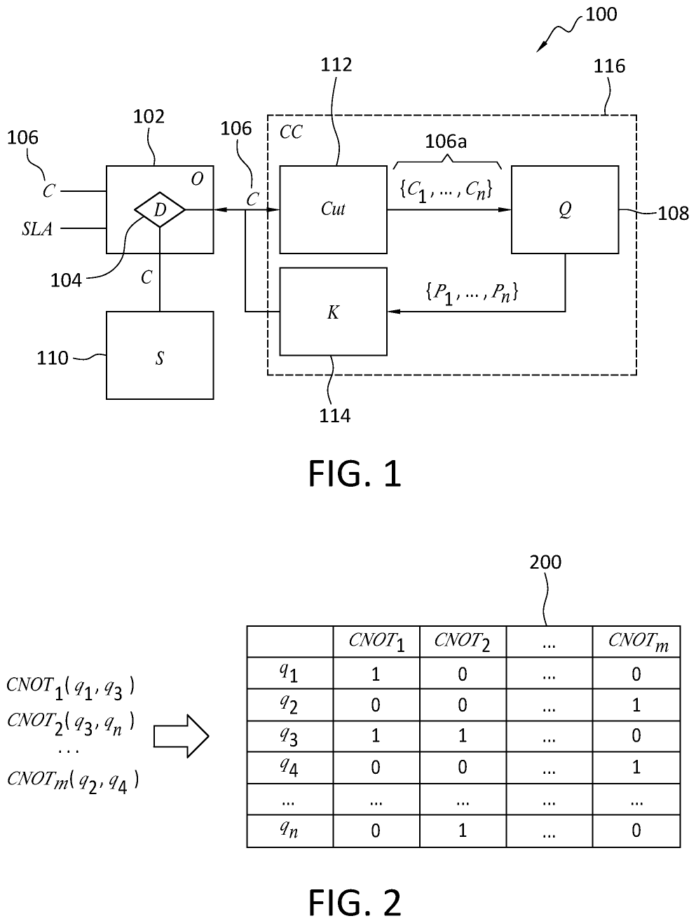

Reference is now made to FIG. 1 which discloses a high-level architecture 100 of an orchestrator deciding between executing a quantum circuit on a quantum device or on a simulation engine to satisfy SLA constraints. Particularly, and as shown in FIG. 1, an embodiment of the invention may comprise an orchestrator 102, 0, which comprises a decision module 104, D, to choose between running a quantum circuit 106, C, on a quantum device 108, Q, or on a simulation engine 110, S, given some SLA constraints. The decision module 104 may perform an operation, or operations, that considers whether, based on the SLA constraints, it is worth cutting, using a cutting module 112, the quantum circuit 106 C into sub-circuits 106a, {C1, . . . , Cn}, before submitting sub-circuits 106a to execution on quantum device 108 Q, which may include post-processing the results of each sub-circuit 106a in a knitting operation performed by a knitting module 114 K. The knitting process receives, from the quantum device, the probability distributions, {P1, . . . , Pn}, on the output states of each sub-circuit, {C1, . . . , Cn}, and compute a single representation for the output state of the original circuit. The cut-execute-knit modules/process is collectively denoted as ‘CC’ 116 in FIG. 1, or individually as process 116 CC or modules 116 CC.

In an embodiment, the orchestrator 102 O may achieve various outcomes and results by embedding two machine learning models that estimate, respectively, SLA metrics of quantum device 108 Q and simulation engine 110 S, as well as SLA metrics of the process 116 CC, based on input comprising the characteristics of the quantum circuit 106 C on the execution characteristics of simulation engine 110 S, quantum circuit 106 Q, and process 116 CC. Below, further information is provided concerning operations that may be used to implement the orchestrator 102 O, including the generation of a data set to train the machine learning model(s).

### B.1 Dataset Generation

In general, a dataset may be created by obtaining data from quantum circuit executions on both simulation engines, and on quantum devices. In the case of simulation engines, one embodiment may extend the data collection process disclosed in U.S. patent application Ser. No. 17/648,065, titled “INTELLIGENT ORCHESTRATION OF CLASSIC-QUANTUM COMPUTATIONAL GRAPHS,” filed 14 Jan. 22, which is incorporated herein in its entirety by this reference. In the case of quantum devices, an embodiment may collect data from the process 116 CC when circuit cutting is required, that is, when quantum circuits use more qubits than available on the quantum hardware device(s). In both cases, an embodiment may collect data that enables the learning of relationships between quantum execution parameters and SLA constraint metrics, such as quantum circuit execution time requirements for example, over a large set of circuit executions on both simulation engines and quantum devices.

### B.1.1 Selecting Quantum Circuit Parameters

For the selection of quantum circuit parameters, an embodiment may extend the data collection process disclosed in U.S. patent application Ser. No. 18/054,565, titled “TRANSPILATION-ORIENTED DECISIONS IN HYBRID QUANTUM-CLASSIC WORKLOAD ORCHESTRATION,” filed 11 Nov. 22, which is incorporated herein in its entirety by this reference. As disclosed in that document, circuits may be generated from random combinations of basic quantum algorithms, such as amplitude amplification, phase estimation, and variational algorithms, with a maximum number of qubits Nmax. Note that, in an embodiment, Nmax should be larger than number qubits of the target quantum hardware of the orchestration process, so that an embodiment can evaluate the efficiency of the process 116 CC as well.

After generating the circuits, an embodiment may collect various circuit-related features, [symbol] c, for each circuit, such as the following:
N: the number of qubits;
D: the depth of the circuit; and
CCNOT: an embedding of the CNOT operations between qubits of the circuit—note that CNOT gates put qubits in an entangled state, which is a relevant factor to influence the performance of both simulation and cutting—namely, the more entangled the circuit is, in terms of the number of qubits participating in CNOT gates, the more costly the process 116 CC tends to be.

### B.1.2 CNOT Embedding

An embodiment may comprise a quantum circuit embedding method that encodes the presence and qubit connectivity implied by CNOT gates. An embodiment may begin the embedding process by transforming a quantum circuit into a type of graph representation that captures only the occurrences of the CNOT gates on the circuit, and the qubits involved. This representation may be translated into a matrix whose rows, or columns, correspond to qubits, numbered from 1 to the maximum number of qubits on the circuit, and whose columns, or rows, correspond to CNOT gates, numbered in the order that the CNOT gates appear on the circuit. Such a matrix [symbol] may comprise a type of adjacency matrix, an example of which is disclosed in FIG. 2, which discloses an adjacency matrix [symbol] that indicates which qubits participate in which CNOT operations. That is, in FIG. 2, an adjacency matrix 200 [symbol] comprises a sparse matrix filled with ‘1’ to indicate which qubits participate in which CNOT operations, and ‘0’ to indicate which qubits do not participate in CNOT operations. For example, and referring to CNOT₁ in FIG. 2, it can be seen from the adjacency matrix 200 that qubits q₁ and q₃ participate in CNOT₁, but qubits q₂, q₄, and qₙ do not participate in CNOT₁.

Alone, the matrix 200 [symbol] may be considered an embedding of the circuit in the [symbol] ^{nxm} space, which may be used as an input feature of a machine learning model. However, each circuit Cᵢ has a matrix [symbol] ᵢ of its own, with dimensions that may be different from circuit to circuit. Thus, an embodiment may interpret each [symbol] ᵢ as a binary image and transform it, via an interpolation algorithm, such as a linear or b-spline algorithm for example, into another image [symbol] ′ᵢ with pre-defined dimensions N×M. After the transformation, matrix values would lie in the interval [0,1]. Now, [symbol] ′ᵢ may be concatenated with other circuit features and fed to the machine learning model.

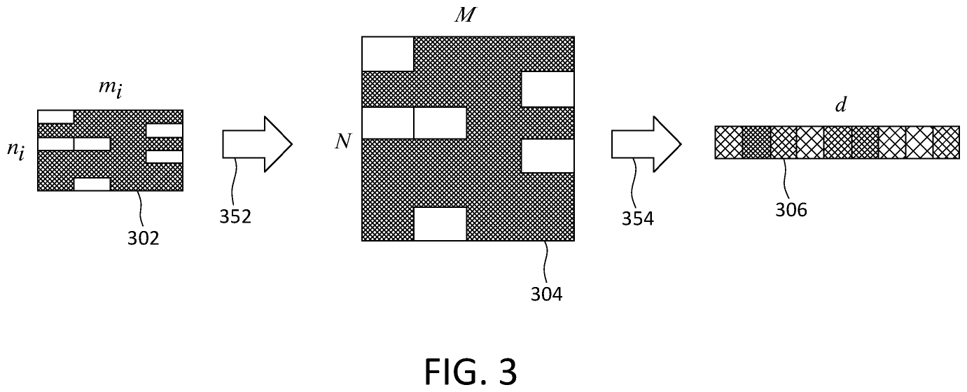

Nonetheless, [symbol] ′ᵢ may still be considered as sparse, possibly even more so than the original matrix if N and M are much larger than the average number of qubits and CNOT gates of the circuits used in the training data set. This may result in poor computation performance, and potentially, some numerical instability. To address this, an embodiment may implement another level of embedding that may reduce the dimensionality of [symbol] ′ᵢ by capturing only the d-dimensional vector that contains the relevant information of [symbol] ′ᵢ. Such dimensionality reduction may be made in several ways, such as by way of principal component analysis or auto-encoders for example, over the entire circuit dataset. In the end, each circuit may be represented by a d-dimensional real vector vᵢ that may be concatenated with the other features of the circuit, as disclosed in the example of FIG. 3, which discloses the transformation of a circuit matrix [symbol] ᵢ into a d-dimensional vector vᵢ. Particularly, the example of FIG. 3 discloses an nxm quantum circuit 302 that may, at a first level of embedding, be converted 352 into a graph representation 304 [symbol] . The graph representation 304 [symbol] may, at a second and subsequent level of embedding, be converted 354 to a vector 306 v of d dimension.

### B.1.3 Collecting Simulation and Circuit Cutting Performance Metrics

An embodiment may operate to estimate simulation and circuit cutting performance metrics that may influence the orchestration decision and, as such, these metrics may be collected from executions of the random quantum circuits that have been generated, as discussed earlier herein. If any of the circuits uses more qubits than those available on the target quantum hardware, an embodiment may also run circuit cutting instances and collect the required SLA metrics pertaining to the circuit cutting operations. In one embodiment, the circuit execution time is the SLA metric in question. Therefore, for each quantum circuit execution in this illustrative, and non-limiting, example, and embodiment may collect the following metrics:
Ts: time to execute the circuit on the simulation engine (S); and
Tc: time to cut-execute-knit the circuit, that is, execute the process CC to [1] cut the circuit, [2] execute the resulting sub-circuits, and then [3] knit the sub-circuits back together after execution, if the circuit uses more qubits than those available on the target hardware, or just the time to execute the circuit on Q if cutting is not required.

### B.2 Machine Learning Model Training and Architecture

In an embodiment, the data collected, that is, the simulation and circuit cutting performance metrics, may be arranged in data set with tuples {F_{ci}, Tₛᵢ, T_{ci}}, where F_{ci} are the features collected for random circuit ci and Tₛᵢ, T_{ci} are the simulation and circuit cutting times for cᵢ, respectively. Using this data, an embodiment may train two machine learning models, Mₛ and M_{c}, that may learn the association between [1] circuit features and [2] execution times for simulation and circuit cutting, respectively. For Mₛ, an embodiment may learn the function ƒ: [symbol] _{c} ∈ [symbol] ^{d}→Tₛ ∈ [symbol] , and, for M_{c}, an embodiment may learn the function ƒ: [symbol] _{c} ∈ [symbol] ^{d}→T_{c} ∈ [symbol] . The loss function, in both cases, may be the mean squared error between the estimated value generated by the ML mode, and the true value, or ground truth. In an embodiment, a neural network may be used for these prediction task(s).

### B.3 Decision Operations

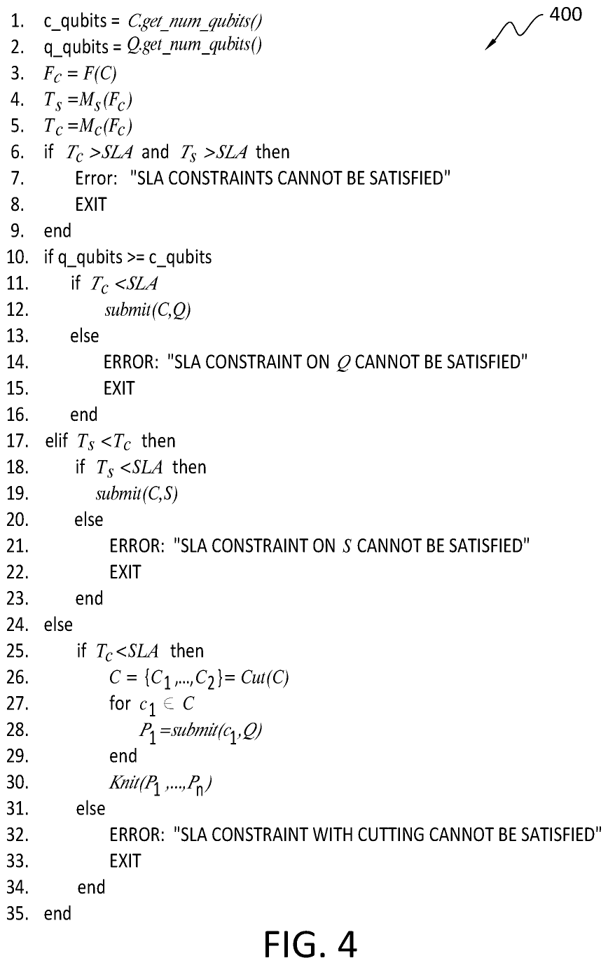

An algorithm, denoted at 400 in FIG. 4, may be run, such as by an orchestrator, to determine whether the circuit should run on the simulation engine S or on the quantum device Q, possibly going through the cutting/knitting process CC when running on the quantum device Q. The example algorithm 400 may start by retrieving the number of qubits of the input circuit and of the target hardware, c_qubits and q_qubits, respectively. The algorithm 400 may then obtain the SLA estimates from the two models of the orchestrator. Next, on line 6, the algorithm 400 may check whether the SLA estimates are above the given SLA constraint and exits with an error in case of failure.

On line 10 of the algorithm 400, if the quantum device has more qubits available than the number of qubits used by the circuit and the SLA constraint can be satisfied, given that in this example, execution time is the SLA constraint, the orchestrator may then simply submit the circuit to the quantum device. In an embodiment, it is expected that the quantum device performs better than the simulator if the former can run the circuit without the need for cutting and knitting.

On line 17 of the algorithm 400, knowing that circuit cannot run on the quantum device, the SLA estimate of both the simulation and of the cutting/knitting process are compared. If execution on the simulation engine is likely to be better and the SLA can be satisfied, the circuit is submitted to the simulation engine, as shown at line 19 of the algorithm 400. Otherwise, if the cutting/knitting process can satisfy the SLA, the subcircuits are obtained via cutting, each subcircuit is submitted to the quantum device, and the returned probabilities are knitted.

### C. Example Methods

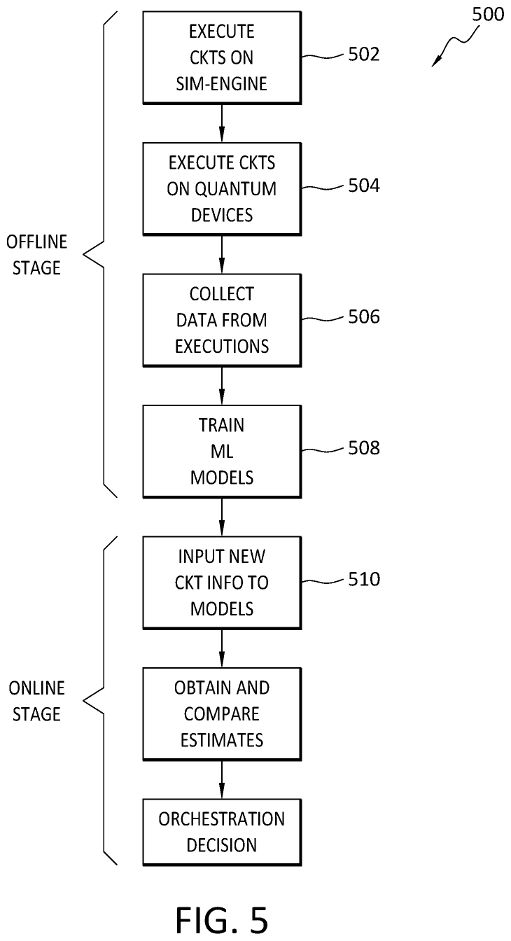

It is noted with respect to the disclosed methods, including the example method of FIG. 5, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 5, a method according to one embodiment is denoted at 500. In an embodiment, part, or all, of the method 500 may be performed by an orchestrator, examples of which are disclosed herein. As indicated in FIG. 5, fin an embodiment, a portion of the method 500 may be performed offline, and another portion of the method 500 may be performed online.

The example method 500 may begin with the execution of various quantum circuits, which may be randomly generated, on a simulation engine 502 that comprises classical computing, that is, non-quantum, infrastructure. As well, the quantum circuits may also be executed on quantum hardware 504. In an embodiment, 502 and 504 may be performed in the reverse order or, in another embodiment, at the same time, or overlapping times.

After the quantum circuits have been executed on the quantum hardware 504 and simulation engine 502, data resulting from those executions may be collected 506. In general, the data collected 506 may be any data concerning the execution of a quantum circuit that is relevant to a parameter specified in an SLA. Thus, in one embodiment, the data collected 506 may comprise execution times, that is, the amount of time needed to execute the quantum circuits on the simulation engine, and on the quantum hardware.

The collected data may then be used to train 508 two ML models, which may be elements of an orchestrator, so that the ML models can learn the association between the features of the quantum circuits that were executed at 502 and 504, and SLA parameters such as execution time. In an embodiment, one of the ML models operates to model the execution of quantum circuits on a simulation engine, and the other ML model operates to model the execution of quantum circuits on quantum hardware. Completion of the training 508 may signal the end of an offline stage that may comprise operations 502 through 508.

After the models have been trained 508, a new circuit may be submitted to the orchestrator for evaluation, that is, for a determination whether that new circuit should be executed on a simulation engine, or on quantum hardware. To that end, features and information concerning new quantum circuits may be input to the models 510. The models may then generate estimates 512, such as estimates of execution times for example. For example, one model may generate an estimate for how long it will take the new circuit to execute on quantum hardware, and the other model may generate an estimate for how long it will take the new circuit to execute on a simulation engine. The execution time on the quantum hardware may include the time necessary to perform any associated cutting and knitting operations.

The estimates, and/or other results generated by the machine models, may then be compared, also at 512. Based on the comparison 512, an orchestration decision may then be made 514, and the new circuit run on either the quantum hardware, or the simulation engine. Some example outcomes of an orchestration process are discussed above in connection with the algorithm 400.

### D. Further Example Embodiments

Following are some further example embodiments of the invention. These are presented only by way of example and are not intended to limit the scope of the invention in any way.

Embodiment 1. A method, comprising: providing quantum circuit information, concerning a quantum circuit, to a first machine learning model that has been trained with first training data generated as a result of execution of a group of quantum circuits on a simulation engine; providing the quantum circuit information to a second machine learning model that has been trained with second training data generated as a result of execution of the group of quantum circuits on quantum hardware; estimating, by the first machine learning model and the second machine learning model, respective values of a quantum circuit execution parameter of the quantum circuit; comparing the estimates of the quantum circuit execution parameter; and based on the comparing, orchestrating the quantum circuit to either the simulation engine, or the quantum hardware, for execution.

Embodiment 2. The method as recited in any preceding embodiment, wherein a choice to orchestrate the quantum circuit to either the simulation engine, or the quantum hardware, is based on a parameter of a service level agreement.

Embodiment 3. The method as recited in any preceding embodiment, wherein the group of quantum circuits comprises randomly generated quantum circuits.

Embodiment 4. The method as recited in any preceding embodiment, wherein the estimates comprise an estimate for a time of execution of the quantum circuit on the quantum hardware, and an estimate for a time of execution of the quantum circuit on the simulation engine.

Embodiment 5. The method as recited in any preceding embodiment, wherein the quantum circuit is arbitrarily sized.

Embodiment 6. The method as recited in any preceding embodiment, wherein each of the machine learning models is operable to learn a relationship between the quantum circuit information and quality of service metrics of running the quantum circuit on either the simulation engine or the quantum hardware.

Embodiment 7. The method as recited in any preceding embodiment, wherein the first training data and/or the second training data comprise ground truth data, and a vectorial representation of one of the quantum circuits in the group of quantum circuits, and that quantum circuit has an arbitrary size and configuration.

Embodiment 8. The method as recited in any preceding embodiment, wherein one of the estimates comprises an estimate for a time of execution of the quantum circuit on the quantum hardware, and the estimate for a time of execution of the quantum circuit on the quantum hardware comprises an amount of time to perform a quantum circuit cutting process, and a quantum circuit knitting process.

Embodiment 9. The method as recited in any preceding embodiment, wherein the first training data and/or the second training data comprise a size, depth, and level of entanglement, of one or more of the quantum circuits in the group of quantum circuits.

Embodiment 10. The method as recited in any preceding embodiment, wherein after the orchestrating, the quantum circuit is executed on the simulation engine, or on the quantum hardware.

Embodiment 11. The method as recited in any preceding embodiment, wherein a CNOT embedding process is performed in which the quantum circuit is transformed into a representation that captures occurrences of CNOT gates in the quantum circuit, and the representation is then translated into a matrix whose rows, or columns, correspond to qubits, numbered from 1 to a maximum number of qubits on the quantum circuit, and whose rows, or columns, correspond to CNOT gates, numbered in an order that the CNOT gates appear on the quantum circuit.

Embodiment 12. The method as recited in any preceding embodiment, wherein the group of quantum circuits comprises one or more randomly generated quantum circuits and/or one or more quantum circuits configured to solve a particular problem.

Embodiment 13. A system, comprising hardware and/or software, operable to perform any of the operations, methods, or processes, or any portion of any of these, disclosed herein.

Embodiment 14. A non-transitory storage medium having stored therein instructions that are executable by one or more hardware processors to perform operations comprising the operations of any one or more of embodiments 1-12.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

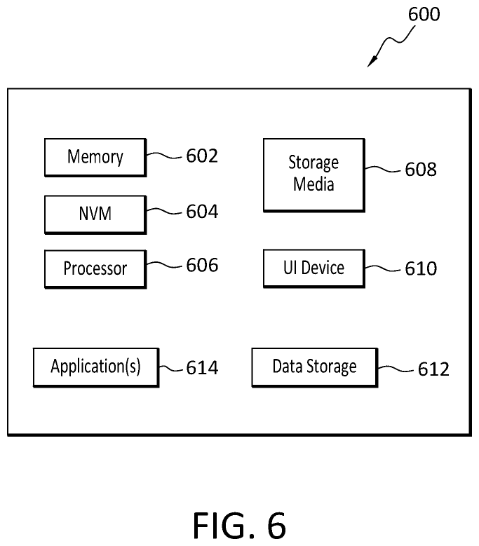

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
providing quantum circuit information, concerning a quantum circuit, to a first machine learning model that has been trained with first training data generated as a result of execution of a group of quantum circuits on a simulation engine;
providing the quantum circuit information to a second machine learning model that has been trained with second training data generated as a result of execution of the group of quantum circuits on quantum hardware;
estimating, by the first machine learning model and the second machine learning model, respective values of a quantum circuit execution parameter of the quantum circuit;
comparing the estimates of the quantum circuit execution parameter; and
based on the comparing, orchestrating the quantum circuit to either the simulation engine, or the quantum hardware, for execution.

2. The method as recited in claim 1, wherein a choice to orchestrate the quantum circuit to either the simulation engine, or the quantum hardware, is based on a parameter of a service level agreement.

3. The method as recited in claim 1, wherein the group of quantum circuits comprises one or more randomly generated quantum circuits and/or one or more quantum circuits configured to solve a particular problem.

4. The method as recited in claim 1, wherein the estimates comprise an estimate for a time of execution of the quantum circuit on the quantum hardware, and an estimate for a time of execution of the quantum circuit on the simulation engine.

5. The method as recited in claim 1, wherein a CNOT embedding process is performed in which the quantum circuit is transformed into a representation that captures occurrences of CNOT gates in the quantum circuit, and the representation is then translated into a matrix whose rows, or columns, correspond to qubits, numbered from 1 to a maximum number of qubits on the quantum circuit, and whose rows, or columns, correspond to CNOT gates, numbered in an order that the CNOT gates appear on the quantum circuit.

6. The method as recited in claim 1, wherein each of the machine learning models is operable to learn a relationship between the quantum circuit information and quality of service metrics of running the quantum circuit on either the simulation engine or the quantum hardware.

7. The method as recited in claim 1, wherein the first training data and/or the second training data comprise ground truth data, and a vectorial representation of one of the quantum circuits in the group of quantum circuits, and that quantum circuit has an arbitrary size and configuration.

8. The method as recited in claim 1, wherein one of the estimates comprises an estimate for a time of execution of the quantum circuit on the quantum hardware, and the estimate for a time of execution of the quantum circuit on the quantum hardware comprises an amount of time to perform a quantum circuit cutting process, and a quantum circuit knitting process.

9. The method as recited in claim 1, wherein the first training data and/or the second training data comprise a size, depth, and level of entanglement, of one or more of the quantum circuits in the group of quantum circuits.

10. The method as recited in claim 1, wherein after the orchestrating, the quantum circuit is executed on the simulation engine, or on the quantum hardware.

11. A non-transitory storage medium having stored therein instructions that are executable by one or more hardware processors to perform operations comprising:
providing quantum circuit information, concerning a quantum circuit, to a first machine learning model that has been trained with first training data generated as a result of execution of a group of quantum circuits on a simulation engine;
providing the quantum circuit information to a second machine learning model that has been trained with second training data generated as a result of execution of the group of quantum circuits on quantum hardware;
estimating, by the first machine learning model and the second machine learning model, respective values of a quantum circuit execution parameter of the quantum circuit;
comparing the estimates of the quantum circuit execution parameter; and
based on the comparing, orchestrating the quantum circuit to either the simulation engine, or the quantum hardware, for execution.

12. The non-transitory storage medium as recited in claim 11, wherein a choice to orchestrate the quantum circuit to either the simulation engine, or the quantum hardware, is based on a parameter of a service level agreement.

13. The non-transitory storage medium as recited in claim 11, wherein the group of quantum circuits comprises randomly generated quantum circuits.

14. The non-transitory storage medium as recited in claim 11, wherein the estimates comprise an estimate for a time of execution of the quantum circuit on the quantum hardware, and an estimate for a time of execution of the quantum circuit on the simulation engine.

15. The non-transitory storage medium as recited in claim 11, wherein the quantum circuit is arbitrarily sized.

16. The non-transitory storage medium as recited in claim 11, wherein each of the machine learning models is operable to learn a relationship between the quantum circuit information and quality of service metrics of running the quantum circuit on either the simulation engine or the quantum hardware.

17. The non-transitory storage medium as recited in claim 11, wherein the first training data and/or the second training data comprise ground truth data, and a vectorial representation of one of the quantum circuits in the group of quantum circuits, and that quantum circuit has an arbitrary size and configuration.

18. The non-transitory storage medium as recited in claim 11, wherein one of the estimates comprises an estimate for a time of execution of the quantum circuit on the quantum hardware, and the estimate for a time of execution of the quantum circuit on the quantum hardware comprises an amount of time to perform a quantum circuit cutting process, and a quantum circuit knitting process.

19. The non-transitory storage medium as recited in claim 11, wherein the first training data and/or the second training data comprise a size, depth, and level of entanglement, of one or more of the quantum circuits in the group of quantum circuits.

20. The non-transitory storage medium as recited in claim 11, wherein after the orchestrating, the quantum circuit is executed on the simulation engine, or on the quantum hardware.
